(19) United States
(12) Patent Application Publication
(10) Pub. No.: US 2022/0242750 A1
(43) Pub. Date: Aug. 4, 2022

(54) PHOTOVOLTAIC DEVICE WITH THERMAL MANAGEMENT

(71) Applicant: TotalEnergies SE, Courbevoie (FR)

(72) Inventors: Frédéric PERIE, Billere (FR); Bruno DELAHAYE, Egly (FR); Matthieu JACOB, Cescau (FR); Lars OBERBECK, Courbevoie (FR); Soukayna AHDIDA, Paris (FR)

(73) Assignee: TotalEnergies SE, Courbevoie (FR)

(21) Appl. No.: 17/621,975

(22) PCT Filed: Jun. 25, 2020
(86) PCT No.: PCT/IB2020/056025

§ 371 Date: Dec. 22, 2021

(30) Foreign Application Priority Data
Jun. 25, 2019 (IB) PCT/IB2019/000758
Sep. 30, 2019 (EP) 19306239.5

(51) Int. Cl. C02F 1/14; C02F 1/72; C02F 3/00; C02F 1/20; C02F 1/44; C02F 1/00; H02S 40/42

(52) U.S. Cl. CPC C02F 1/14; C02F 1/72; C02F 3/00; C02F 2103/007; C02F 1/44; C02F 1/008; H02S 40/425; C02F 1/20

(57) ABSTRACT

The present invention relates to a device comprising a photovoltaic system, a water treatment system, a first heat exchanger, a second heat exchanger, a first fluidic circuit for circulating a first fluid through said first heat exchanger, said first heat exchanger being in thermal contact with said photovoltaic system, and a second fluidic circuit for circulating said second fluid through said second heat exchanger and through said water treatment system.

### CROSS-REFERENCE TO RELATED APPLICATIONS

This application is a U.S. National Phase of International Patent Application No. PCT/IB2020/056025, filed on Jun. 25, 2020, which claims priority to and European Application No. 19306239.5, filed Sep. 30, 2019, and International Application No. PCT/IB2019/000758, filed Jun. 25, 2019. The entire contents of these applications are incorporated herein by reference in their entirety.

### FIELD OF THE INVENTION

The present invention concerns a photovoltaic device with thermal management and a method of managing a photovoltaic device with thermal management.

### BACKGROUND

Water from different sources should be treated for providing water for various uses, including drinkable water. Many devices for treating water are known in the art. One important treatment is water desalination. Desalination plays a pivotal role in the water industry and to mitigate water scarcity.

US 2016/0362309 relates to systems and methods wherein hot fluids extracted from the geothermal well may be utilized to generate geothermal energy that can be utilized to power desalination devices to removal minerals and/or salt from produced water from another well. These hot fluids may be recirculated back into the geothermal well to gather heat and to form a closed-looped system that provides thermal energy to the desalination unit. The treated water may be stored for latter agricultural, municipal, and/or other use, or it may be utilized further hydraulic fracturing.

US 2012/0211409 relates to a photovoltaic-powered reverse osmosis system. The system includes a photovoltaic panel for generating electricity and includes a heat exchanger in thermal contact with the photovoltaic panel. The salt-containing feed water is fed to a reverse osmosis unit to produce clean water therefrom. Fluid circuitry, including a pump, circulates the feed water through the heat exchanger to cool the photovoltaic panel and to heat the feed water. It also delivers the heated feed water to the reverse osmosis unit for desalination.

However, performance of devices of the prior art for treating water can still be improved.

### SUMMARY

The present invention aims to solve the technical problem of providing a device and method for treating water having improved efficiency, notably in term of energy saving.

The present invention also aims to solve the technical problem of providing a device and method for improving electrical energy production efficiency of a solar panel.

The present invention aims to solve the technical problem of providing a device and method for treating water having improved efficiency, notably in term of energy saving, wherein said device and method also improves electrical energy production efficiency of a solar panel.

In particular, the present invention aims to solve the technical problem set forth by the present invention in isolated sites, not connected to an electricity grid and not having fatal low-energy heat available to work a water treatment system.

In particular, the present invention aims to solve the technical problem of water desalination, in particular of water desalination in isolated sites, not connected to an electricity grid and not having fatal low-energy heat available to work a water treatment system, such as for example in geographical area remote from coastal areas.

### BRIEF DESCRIPTION OF THE FIGURES

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is a schematic representation of a system 1 or process according to one embodiment of the present invention.

FIG. 2 is a schematic representation of a system 1 or process according to another embodiment of the present invention.

FIG. 3 is a schematic representation of a system 201 or process according to a further embodiment of the present invention.

FIG. 4 is a schematic representation of a cooling circuit according to a further embodiment of the present invention.

FIG. 5 is a schematic representation of a system 201 or process according to yet another embodiment of the present invention.

### DETAILED DESCRIPTION

The detailed description is given by reference to the figures for explanatory purposes only as the invention extends beyond the limited embodiments of the figures. An embodiment, preferred or advantageous feature described, for example in relation to a figure, is combinable with any device or process according to the invention, unless technically impossible.

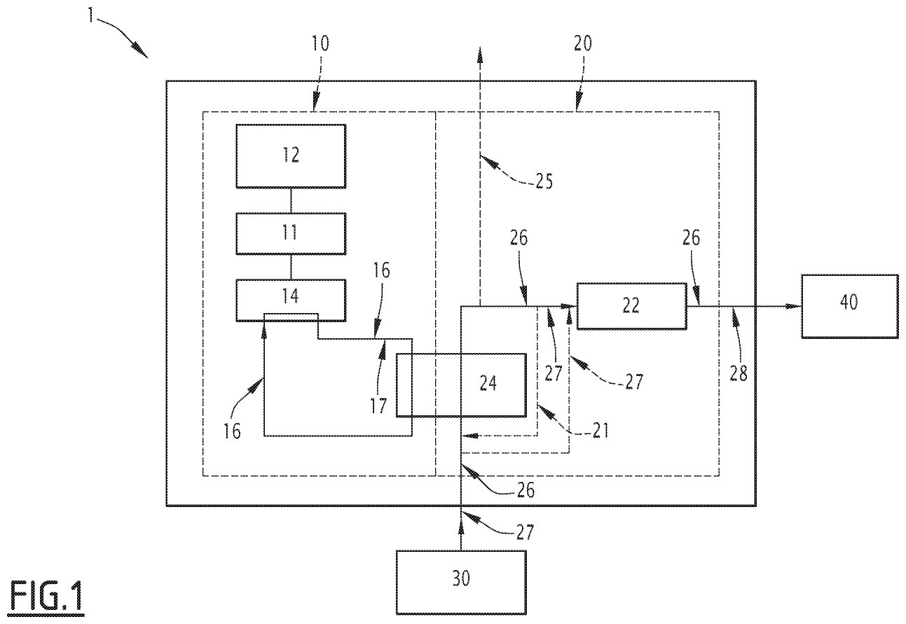

In a first aspect, the present invention relates to a device 1 comprising a photovoltaic system 12, a water treatment system 22, a first heat exchanger 14, a second heat exchanger 24, a first fluidic circuit 16 for circulating a first fluid 17 through said first heat exchanger 14, said first heat exchanger 14 being in thermal contact with said photovoltaic system 12, and a second fluidic circuit 26 for circulating said second fluid 27 through said second heat exchanger 24 and through said water treatment system 22 (see for example FIG. 1).

Typically, said photovoltaic system 12, said first heat exchanger 14 and said first fluidic circuit 16 form a photovoltaic unit 10 and wherein said water treatment system 22, said second heat exchanger 24 and said second fluidic circuit 26 form a water treatment unit 20.

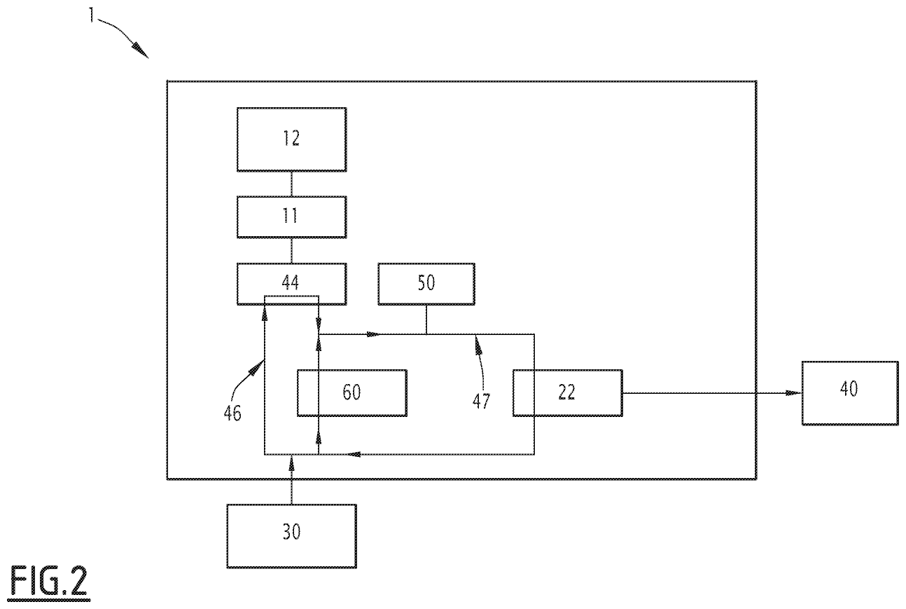

The present invention relates also to a device 1 comprising a photovoltaic system 12, a water treatment system 22, a heat exchanger 44, a pressure exchanger 60, a fluidic circuit 46 for circulating a fluid 47 through said heat exchanger 44 and through said water treatment system 22, said heat exchanger 44 being in thermal contact with said photovoltaic system 12, said device comprising a temperature controller 50 controlling the temperature of the fluid in said fluidic circuit 46, said fluid circulating through said pressure exchanger 60 downstream the water treatment system 22, said pressure exchanger 60 feeding said fluid upstream said water treatment system 22 (see for example FIG. 2).

The present invention relates also to a process for treating water, wherein said process implements a device 1 according to the present invention, comprising a photovoltaic system 12, a water treatment system 22, a first heat exchanger 14, a second heat exchanger 24, a first fluidic circuit 16 and a second fluidic circuit 26, wherein said process comprises circulating a first fluid 17 in said first fluidic circuit 16 and through said first heat exchanger 14, wherein said first heat exchanger 14 is in thermal contact with said photovoltaic system 12, and wherein said process comprises circulating a second fluid 27 in said second fluidic circuit 26, through said second heat exchanger 24 and through said water treatment system 22.

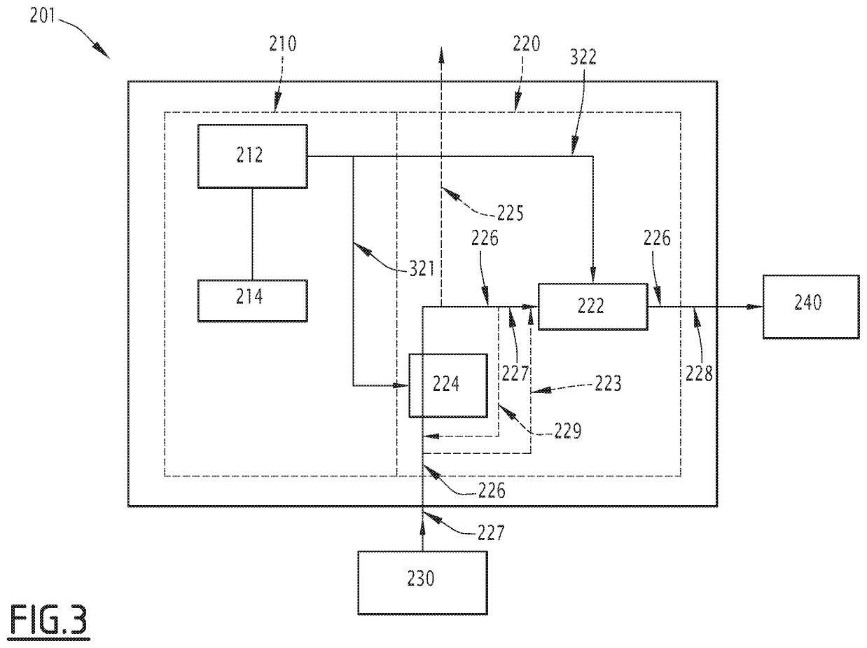

In a second aspect, the present invention relates to a device 201 comprising a photovoltaic system 212, a water treatment system 222, a cooling system 214, an electric heating system 224, and a fluidic circuit 226 for circulating said fluid 227 in contact with said electric heating system 224 and through said water treatment system 222, said photovoltaic system 212 providing electricity 321 to said electric heating system 224 and said photovoltaic system 212 exchanging heat with said cooling system 214 (see for example FIG. 3).

Typically, said photovoltaic system 212 and said cooling system 214 form a photovoltaic unit 210 and said water treatment system 222, said electric heating system 224 and said fluidic circuit 226 form a water treatment unit 220.

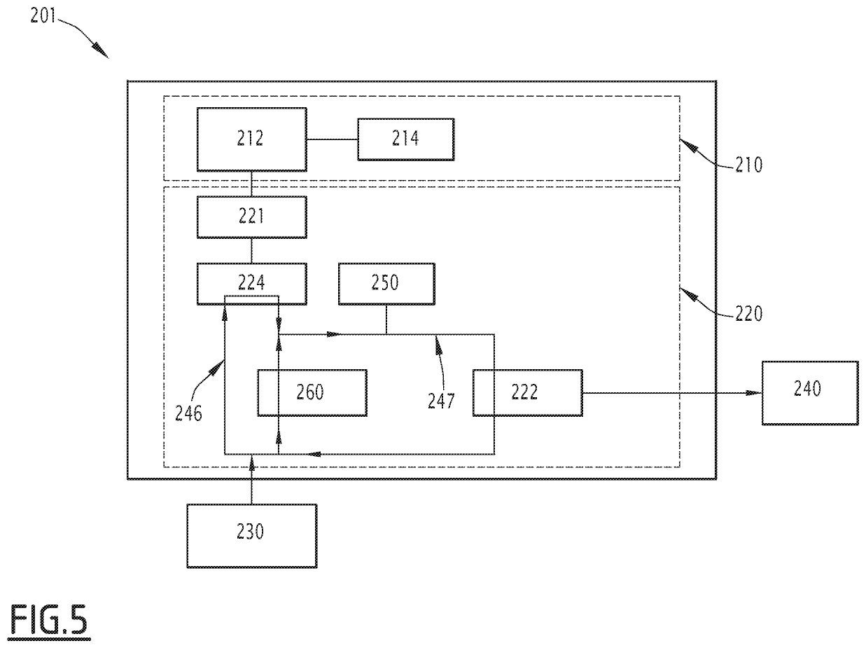

The present invention relates also to a device 201 comprising a photovoltaic system 212, a water treatment system 222, an electric heating system 224, a pressure exchanger 260, a fluidic circuit 246 for circulating a fluid 247 in contact with said electric heating system 224 and through said water treatment system 222, said electric heating system 224 being in electric contact with said photovoltaic system 212, said device comprising a temperature controller 250 controlling the temperature of the fluid in said fluidic circuit 246, said fluid circulating through said pressure exchanger 60 downstream the water treatment system 222, said pressure exchanger 260 feeding said fluid upstream said water treatment system 222 (see for example FIG. 5).

The present invention relates also to a process for treating water, wherein said process implements a device 201 according to the present invention, comprising a photovoltaic system 212, a water treatment system 222, a cooling system 214, an electric heating system 224, a fluidic circuit 226, wherein said process comprises circulating a fluid 227 in said fluidic circuit 226, in contact with said electric heating system 224 and through said water treatment system 222, said photovoltaic system 212 providing electricity 321 to said electric heating system 224, and wherein said photovoltaic system 212 exchanges heat with said cooling system 214.

Said electricity 321 is provided as electrical input to operate said electric heating system 24.

Typically, said electric heating system 224 is in electrical contact with said photovoltaic system 212 and in fluidic contact with said water treatment system 222. Typically, the fluidic circuit 226 comprises electric heating system 224, for example an electrical resistance heating equipment, to transfer heat to the fluid 227 prior to said water treatment system 222.

In the prior art, the fluid used to reduce the temperature of photovoltaic systems are collected for heating a defined space (heating in a building) or for production of domestic hot water. Cooling of solar panels by water circulation to recover this water for thermal purposes (central heating or production of domestic hot water) is known. The solar panels are also air-cooled either to ensure the drying of wet material (biomass/wood/etc.) or for domestic heating. Photovoltaic devices are well known but need further improvement in terms of thermal management. Indeed, the skilled person knows that the electric conversion performance of most PV devices, incl. devices based on crystalline silicon, decreases with increasing temperature. There are efforts to decrease the operating temperature of photovoltaic modules.

The present invention improves the thermal management of solar panels.

In the present invention, typically said fluid 227 or second fluid 27 contains water and are thus aqueous fluids.

In one embodiment, said fluid 227 or second fluid 27 is water optionally containing other components.

In one embodiment, said first fluid 17 and said second fluid 27 are different in their chemical composition.

It has been discovered that a device or method according to the present invention improves the efficiency of said water treatment system 22, 222 by implementing said photovoltaic system 12, 212.

Advantageously, the present invention allows heat (calories) to be removed from said photovoltaic system 12 in order to improve the efficiency of the water treatment.

Advantageously, the present invention improves at the same time the efficiency of a photovoltaic system and of a water treatment system.

In one embodiment, heat produced by said photovoltaic system 12,212 and collected by a heat exchanger, typically the first heater 14, is transferred to said water treatment system 22, 222.

In one embodiment, said second fluid 27 exchanges heat with said second heat exchanger 24 before entering said water treatment system 22.

In one embodiment, said first fluid 17 exchanges heat with photovoltaic system 12 in said first heat exchanger 14 and before entering said second heat exchanger 24.

In one embodiment, electrical energy collected from said photovoltaic system 12 is used for a different purpose than said water treatment.

In one embodiment, electrical energy collected from said photovoltaic system 12, 212 is used in part for said water treatment and in part for a different purpose than said water treatment.

Typically, said photovoltaic system 12, 212 comprises a plurality of solar panels.

Preferably, said photovoltaic system 12, 212 provides electric energy to said water treatment system 22, 222. In one embodiment, the electric energy of said photovoltaic system 12, 212 is used as electrical input to operate said water treatment system 22, 222.

In one embodiment, the electric energy of said photovoltaic system 12, 212 is used to transfer heat to the second fluid. In such an embodiment, the fluidic circuit 226 or second fluidic circuit 26 comprises for example an electrical resistance heating equipment to transfer heat to the fluid 227 or second fluid 27 prior to said water treatment system 22, 222.

In one embodiment, said photovoltaic system 12, 212 provides electric energy to electrically powered devices.

In one embodiment, electrical energy collected from said photovoltaic system 212 is used in addition for a different purpose than providing only electricity to said electric heating system 224.

In one embodiment, electrical energy collected from said photovoltaic system 212 is used in part for providing electricity 321 to said electric heating system 224 and in part for a different purpose.

In one embodiment, said photovoltaic system 12, 212 provides electric energy to said water treatment system 22, 222 and to electrically powered devices.

Advantageously, by reducing the temperature of solar panels by way of said first heat exchanger 14 or said cooling system 214, the present invention improves electrical energy production efficiency of solar panels.

Advantageously, in an embodiment, increasing the temperature of said fluid 227 or second fluid 27 reduces the dynamic viscosity of said fluid 227 or second fluid 27.

Advantageously, in an embodiment, increasing the temperature of said fluid 227 or second fluid 27 reduces the consumption of electrical energy required to transfer a given quantity of fluid 227 or second fluid 27 through said water treatment system 22, 222.

Advantageously, in an embodiment, the lower the solar panel temperature, the better the electrical production efficiency. For example, a solar panel with a temperature coefficient of −0.5%/° C. loses 0.5% relative in power output with 1° C. increase in temperature for typical operating temperatures.

Advantageously, increasing the temperature of said fluid 227 or second fluid 27 reduces the consumption of energy on thermal water treatment system or method.

Advantageously, increasing the temperature of said fluid 227 or second fluid 27 increases the mobility of ions typically contained in said fluid 227 or second fluid 27 and improves the transfer through said water treatment system 22, 222, for example in particular in case of treatment involving one or more electrodialysis membranes. Indeed, ion mobility increases with temperature thereby improving performance of dialysis of 85% between 25 and 70° C.

In one embodiment, said water treatment comprises a chemical and/or biological reaction in said water treatment system 22, 222, thereby modifying the composition of said fluid 227 or second fluid 27. It is referred to as fluid modification in the present invention. Advantageously, increasing the temperature of said fluid 227 or second fluid 27 increases the reaction kinetics of said fluid 227 or second fluid 27 when said fluid 227 or second fluid 27 is modified by chemical and/or biological reaction. Accordingly, in one embodiment the present invention improves chemical and/or biological reactions by improving reaction kinetics.

Advantageously, the present invention improves the electrical energy production efficiency, the water treatment efficiency and the global process (or method or system) efficiency.

Advantageously, the water treatment benefits from a temperature increase either by modifying the dynamic viscosity or by modifying the reaction kinetics, in particular in case of a chemical and/or biological oxidation reaction. An example of the modification of the dynamic viscosity: between 25 and 85° C. the dynamic viscosity decreases from 0.000891 kg/ms to 0.000334 kg/ms, a decrease of 62.5%.

In the case of membrane separation, the transmembrane flow depends on the temperature and therefore on the viscosity of the fluid according to the relationship: JT=JT0 μT/μT0 either by considering the temperatures of 25 and 85° C. J85=0.000891/000334.J25, i.e. J85=2.67.J25.

A heat transfer between said photovoltaic system 12 and said water treatment system 22 benefits to both unitary systems (12 and 22) (and to both unitary operations).

Advantageously, the coupling and integrated photovoltaic-water treatment systems and methods according to the present invention offer a better energy efficiency than the installation not benefiting from heat exchange between the photovoltaic and water treatment systems. Advantageously, Operational expenditure (OPEXs) can be expected to decrease through the implementation of heat exchange.

Advantageously, said second heat exchanger 24 or said electric heating system 224 is used to facilitate the thermal optimization of the system 1, 201. In particular, the present invention allows the flow rate of the first fluid 17 to be decoupled from the water supply rate of the water treatment system 22 (second fluid 27) or the present invention allows the electrical energy provided by the cooling of the PV panel to be used for working the electric heating system 224 Advantageously, the surface temperatures of the photovoltaic panels of the photovoltaic system 12, 212 and the temperature of the second fluid 27 to be optimized separately. The preferred parameters to be adjusted or monitored to control the temperature of the photovoltaic panels in the photovoltaic system 12, 212 and the temperature of the water treatment system 22, 222 are the heat exchange surface, the materials and design of the heat exchangers 14, 24, 214, 224, the circulation rate in the fluidic circuit 226, the circulation rate in the first fluidic circuit 16, the circulation rate in the second fluidic circuit 26 and the flow rate of the fluid 227 or second fluid 27 to be treated in the second heat exchanger 24, 224 (or the circulation rate in the second fluidic circuit).

An advantage of the closed loop of the first fluidic circuit 16 during operation is to avoid clogging problems with the first heat exchanger 14, notably by limiting the formation of deposits in the first heat exchanger 14.

The present invention has the technical advantage of controlling the quality of the first fluid 17 thereby controlling or optimizing operating conditions of the first heat exchanger 14 and/or the second heat exchanger 24.

An advantage of the present invention is also to limit or even eliminate the formation of a biofilm in the first fluid 17.

An advantage of the present invention is to implement photovoltaic panels that do not require the use of materials that are resistant to corrosion.

In one embodiment, said second heat exchanger 24 or electric heating system 224 is resistant to corrosion. Appropriate material are known by the skilled person.

Advantageously, the present invention limits the influence of intermittency related to solar resources, typically without using battery electricity storage, or by limiting the use of a battery to completely replace photovoltaic panels.

In one embodiment, said electric heating system 224 is a water heating system.

Typically, said electric heating system 224 is selected from the group consisting of immersion heaters, circulation heaters, electrode heaters, induction heaters, etc.

In one embodiment, the electric contact between said PV system 212 and said electric heating system 224 comprises a modulator 221 modulating the electricity provided to said electric heating system 224, and thereby advantageously improves the electric heating system by better supporting intermittencies in the electricity 321, 322 provided by the PV system 212. Such modulator 221 is only represented on FIG. 5, but a device or process according to FIG. 1 to 5 or any other embodiment according to the invention may comprise such a modulator 221.

In one embodiment, said electric heating system 224 comprises a heat storage system. Advantageously, a heat storage system (comprising or not active materials storing heat or a passive heat storage system (like for Domestic Hot Water)) improves the electric heating system by better supporting intermittencies in the electricity 321, 322 provided by the PV system 212.

A device or process according to any one of FIGS. 1 to 5 or any other embodiment according to the invention may comprise such a heat storage system. Typically, a heat storage system is in contact with the fluidic circuit 226 or second fluid 26.

In one embodiment, said device comprises a buffer reservoir in a position to feed said fluid 27, 227 by gravity flow to said water treatment system 22, 222. Advantageously, such buffer reservoir allows the system to run with or without pump and may allow to bring water by gravity flow.

Typically, the electric heating system 224 is used to heat up the fluid 227 which is fed to the water treatment system 222.

In one embodiment, said cooling system 214 comprises or consists of a passive air cooling.

In one embodiment, said cooling system 214 comprises or consists of a cooling fluid 217 circulating in a cooling circuit 216. Typically, in such an embodiment, said cooling system 214 comprises a heat exchanger with a cooling circuit 16 for circulating a cooling fluid 217 through said heat exchanger.

Typically, said cooling system 214 is selected from the group consisting of plate heat exchanger, solid thermal exchanger, solid phase change material coupled with solid thermal exchanger, flat coil polymeric exchanger etc.

Typically, the first heat exchanger 14 or cooling system 214 is a system added to one or more photovoltaic panels. The first fluid 17 or cooling fluid 217 typically circulates to extract heat and cool down the panel.

In one embodiment, said cooling fluid 217 and said fluid 227 are different in their chemical composition.

The present invention has the technical advantage of controlling the quality of the cooling fluid 217 thereby controlling or optimizing operating conditions of the cooling system 214 and/or the electric heating system 224.

An advantage of the present invention is also to limit or even eliminate the formation of a biofilm in the cooling fluid 217.

Typically, said second heat exchanger 24 is selected from the group consisting of plate heat exchanger, tubular vertical or horizontal, u-shape, straight exchangers, spiral exchanger, etc.

Typically, the second heat exchanger 24 is used to heat up the second fluid 27 which is fed to the water treatment system 22.

Typically, the first fluid 17 or cooling fluid 217 is selected from the group consisting of a mono- or multi-phases aqueous or non-aqueous fluid, for example water, a gaz, for example air, a coolant, a liquid with one or more phase change materials (PCM), and any mixture of at least two of these components.

In one embodiment, said cooling fluid 217 comprises or consists of a gas, for example air.

In one embodiment, the first fluid 17 or cooling fluid 217 is a coolant.

In one embodiment, the first fluid 17 or cooling fluid 217 is a coolant comprising one or more PCM.

In one embodiment, the first fluid circuit 16 comprises one or more phase change materials either suspended in the first fluid 17 (and part of the fluid composition) or fixed at the first heat exchanger 14 and/or the second heat exchanger 24 in contact with said first fluid 17 to exchange easily heat with said first fluid 17.

In one embodiment, the cooling circuit 216 comprises one or more phase change materials either suspended in the cooling fluid 217 (and part of the fluid composition) or fixed in the cooling system 214 in contact with said cooling fluid 217 to exchange easily heat with said cooling fluid 217.

In one embodiment, the second fluid circuit 26 comprises one or more phase change materials either suspended in the second fluid 27 (and part of the fluid composition) or fixed at the second heat exchanger 24 in contact with said second fluid 27 to easily exchange heat with said second fluid 27.

In one embodiment, said first fluid 17 comprises or consists of one or more heat transfer compound, for example one or more phase change materials (PCM).

In one embodiment, the fluid circuit 226 comprises one or more phase change materials either suspended in the fluid 227 (and part of the fluid composition) or fixed in a dedicated area of the fluidic circuit 226 in contact with said fluid 227 to easily exchange heat with said fluid 227.

By using a phase change material, heat recovery is maximized by recovering the latent heat of fusion from the phase change material chosen to change phase at a temperature below the surface temperature of the photovoltaic panel(s) of the photovoltaic system 12 and corresponding to the operating temperature of the water treatment system 22 (e. g. 45° C. for reverse osmosis). Advantageously, this constant temperature heat recovery is obtained without prejudice to the recovery of the heat corresponding to the temperature difference between the surface temperature of the photovoltaic panel(s) of the photovoltaic system 12 and the temperature of the first or cooling fluid, containing the phase change material according to this embodiment.

In one embodiment, said first fluidic circuit 16 and said second fluidic circuit 26 are in thermal contact in said second heat exchanger 24.

Advantageously, said first fluid 17 or cooling fluid 217 circulates in closed loop in said first fluidic circuit 16 or cooling circuit 216.

An advantage of a closed loop of said first fluidic circuit 16 or cooling fluid 216 during operation is to avoid clogging problems with the first fluidic circuit 16 or cooling fluid 216, notably by limiting the formation of deposits in the first fluidic circuit 16 or cooling circuit 216.

In one embodiment, said second fluid 27 exchanges heat with said second heat exchanger 24 before entering said water treatment system 22.

In one embodiment, said first fluid 17 exchanges heat with photovoltaic system 12 in said first heat exchanger 14 and before entering said second heat exchanger 24.

In one embodiment, said cooling fluid 217 exchanges heat with photovoltaic system 212 through said cooling system 214.

In one embodiment, said first heat exchanger 14 or cooling system 214 reduces the temperature of said photovoltaic system 12, 212.

Advantageously, said fluid 227 exchanges heat with said electric heating system 224 before entering said water treatment system 222.

Preferably, said water treatment system 22, 222 improve its performances at higher temperature or require a process step at higher temperature than feed temperature.

Typically, said water treatment system 22, 222 is a treatment of industrial or domestic water in all aspects of transformation (including for example chemical (oxidation, reduction), physics (ultrasound, precipitation) or separation (membrane techniques, evapo concentrations, evapo crystallization), humidification, dehumidification).

Advantageously, said water treatment system 22, 222 is implemented where the application benefit from a heat supply, such as for example pump and treat, venting, sparging, in situ oxidation, in situ electrical treatment, such as for example for supplying hot water to an electrode, in situ or ex situ biodegradation, mobilization by steam sweeping.

In one embodiment, said water treatment system 22, 222 is selected from the group consisting of a desalination system (microfiltration, ultrafiltration, reverse osmosis, nanofiltration, electrodialysis, distillation/evaporation, humidification-deshumidification, solvent extraction, clathrate based desalination), an oxidation system (ozone, any advanced oxidation processes), a bioreactor, a solid-liquid-liquid separation process (flotator, hydrocyclone, settling tanks, centrifugation), a liquid-liquid separation process, a liquid gas separation process, a thermal treatment such as evaporation, evapo-concentration, humidification-dehumidification, a membrane separation system, a treatment of industrial or domestic water, of natural surface or groundwater including contaminated groundwater, and combination thereof.

Typically, said device comprises one or more controller selected from the group consisting of a controller of the flow rate of the first fluid in the first fluidic circuit, a controller of the flow rate of the second fluid in the second fluidic circuit, a controller of the temperature of the first fluid in the first fluidic circuit, a controller of the temperature of the photovoltaic system 12, a controller of the temperature of the second fluid in the second fluidic circuit.

Typically, said device comprises one or more controller selected from the group consisting of a controller of the flow rate of the cooling fluid 217 in the cooling circuit 16, a controller of the flow rate of the fluid 227 in the fluidic circuit 226, a controller of the temperature of the cooling fluid 217 in the cooling circuit 16, a controller of the temperature of the photovoltaic system 212, a controller of the temperature of the fluid 227 in the fluidic circuit 226. The controllers are not specifically shown on the figures, except the temperature controller 250 on FIG. 5 as an illustrative purpose of an embodiment.

A control system is used to optimize and/or enhance the efficiency and the flux of water treated based on a double loop heat extraction system according to the present invention. The control system is designed to maximize the heat recovery from the panel of the photovoltaic unit 10, 210 and adjust the required amount of heat to manage the water treatment unit 20, 220. In an embodiment, the control system allows setting the flow rates and/or the temperatures to the selected values. In an embodiment, the control system adjusts all required parameters for the designed water treatment unit 20, 220 including pressure of unit 20.

In an embodiment, the fluidic circuit 26 includes a purge 25 and a pressure control system.

In an embodiment, the fluidic circuit 226 comprises a temperature controller 250 controlling the temperature of the fluid in said fluidic circuit 226.

In an embodiment, the device 1, 201 comprises a pressure exchanger 60, 260, said fluid 227 or second fluid 27 circulating through said pressure exchanger 60, 260 downstream the water treatment system 22, 222, said pressure exchanger 60, 260 feeding said fluid upstream said water treatment system 22, 222. Typically the device 1, 201 comprises a pressure controller (not shown in the figures).

One closed loop for heat extraction from the PV panels is represented by said first fluidic circuit 16 or cooling fluid 216 and one loop for the water treatment is represented by said second fluidic circuit 26 or fluidic circuit 226. In one embodiment, the second fluid 27 is fed to said water treatment system 22, 222 after temperature increase through the second heat exchanger 24 interfacing the two units 10,20. This control system is designed for thermal management of the photovoltaic system 12 and the feed in second fluid 27 before the water treatment system 22, for pressure regulation of the first fluidic circuit 16, and the second fluidic circuit 26, for the optimization of the production and/or efficiency of the photovoltaic system 12 and of the water treatment system 22.

In one embodiment, the fluid 227 is fed to said water treatment system 222 after temperature increase in contact with said electric heating system 224. of the cooling circuit 16, and the fluidic circuit 26, for the optimization of the production and/or efficiency of the photovoltaic system 12 and of the water treatment system 22.

In one embodiment, the control system comprises a storage device storing the electrical energy produced by the photovoltaic system 12, 212 for the optimization or extension of the functioning of said water treatment system 22, 222 for example further the sunset or in case of variation to solar exposition of the photovoltaic system 12, 212. In one embodiment, the energy storage comprises or consists of one or more batteries for storing electricity produced by the photovoltaic system 12, 212.

In one embodiment, the control system comprises a storage device storing the heat produced by the photovoltaic system 12, 212 though the heater 214 or first heater 14 for the optimization or extension of the functioning of said water treatment system 22, 222 for example further the sunset or in case of variation to solar exposition of the photovoltaic system 12, 212.

In one embodiment, the energy storage comprises or consists of one or more heat storage devices, such as for example coolant, or water tanks or device working with PCM, for storing heat produced by said water treatment system 22, 222.

In one embodiment, the thermal management comprises one or more devices measuring as input the temperature of one or more solar panels of the photovoltaic system 12, the temperature of the second heat exchanger 24 or of the electric heating system 224, the temperature of the water source 30 or the fluid 227 or the second fluid 27 before upstream the second heat exchanger 24 or the electric heating system 224 and the temperature of the fluid 227 or second fluid 27 before water treatment system 22, 222 and after the second heat exchanger 24 or the electric heating system 224.

Preferably, the regulation of the thermal management is performed by controlling the speed of the flow through the closed first fluidic circuit 16 or cooling fluid 216, of the flow through the second fluidic circuit 26 or fluidic circuit 226, in relation with the dimensions of the first heat exchanger 14 or heat exchanger 214, and in relation with the dimensions of the second heat exchanger 24 or electric heating system 224, in order to keep the temperature of the PV panel(s) of the photovoltaic system 12, 212 at the minimum or optimal temperature, and the temperature at the input of the water treatment system 22, 222 at a maximum or optimal temperature, respecting constraint of such water treatment system 22, 222 such as for example a reverse osmosis system to avoid any degradation thereof.

Typically, the speed and the flow of the fluids is controlled by pumps and valves in the fluidic circuits.

A system of valves and purge can be used to regulate the temperature in the fluidic circuit 226 or second fluidic circuit 26.

In one embodiment, the device 1 comprises a pressure regulation system.

In one embodiment, the pressure regulation system controls the pressure of the first fluid 17 or cooling fluid 217 inside the first heat exchanger 14 or cooling system 214 (typically on the back of the PV panels) and/or of the fluid 227 in contact with said electric heating system 224 or of the second fluid 27 inside the second heat exchanger 24 within limits defined by the design of the cooling system 214 or these heat exchangers 14, 24 and/or electric heating system 224.

In one embodiment, the pressure regulation system monitors the pressure of fluid 227 or second fluid 27 feeding the water treatment system 22, 222, thereby adjusting the flow at the optimal pressure for operating the water treatment system 22, 222, typically depending on the treatment to perform.

Advantageously the pressure regulation system regulates (or controls) the pressure to compensate intermittency of the solar irradiance of the photovoltaic system 12, 212.

For example, the pressure regulation system comprises one or more clark pumps or any type of pressure exchanger.

In one embodiment, said photovoltaic unit 10, 210 and/or said water treatment unit 20, 220 comprise storage tank. Advantageously, one or more storage tanks smooth out the intermittency of photovoltaic system performance and/or the first heat exchanger or cooling system performance. In such an embodiment, it is possible to extend the optimal heat exchange conditions beyond the moment when the irradiation decreases rapidly and becomes less than optimal for the photovoltaic system.

Typically, said fluidic circuit 226 or second fluidic circuit 26 is fed by a source 30, 230 of water to be treated, and said fluid 227 or second fluid 27 comprises or consists of water to be treated.

Water source 30, 230 is ground water, produced water, process water, industrial water, drinking water, purified water, deionized water, rain water, domestic water, tap water, river or lake water, waste water, sea water, brackish water, steam condensate, melted ice, contaminated water, etc.

In one embodiment, the treated fluid 228 or treated second fluid 28 forms a modified fluid, typically fluid having undergone a chemical and/or biological reaction.

In one embodiment, the treated fluid 228 or treated second fluid 28 forms a clean fluid, typically clean water.

In one embodiment, said clean or modified fluid is collected and/or stored in a tank 40, 240.

Accordingly, the device 1, 201 comprises one or more water tank for the collection of (clean) water after its treatment in the water treatment system 22, 222.

In one embodiment the process of the invention comprises desalinizing water from a water source 30, 230 by said water treatment system 22, 222.

In one embodiment the process of the invention comprises modifying the composition or the quality of a water from a water source 30, 230 by said water treatment system 22, 222.

FIG. 1 is a schematic representation of a system 1 or process according to one embodiment of the present invention.

In an example, water is collected from a source 30. Said water is circulated in a second fluidic circuit 26. Such water represents a second fluid 27 according to the invention and circulates through a second heat exchanger 24. Downstream said second heat exchanger 24, said second fluid 27 passes through a water treatment system 22, for example a desalination system comprising a reverse osmosis membrane, wherein said second fluid 27 is modified as a treated fluid 28 by said water treatment system 22. Downstream said water treatment system 22, the treated fluid 28 is sent to a tank 40 and/or to a recirculation pipe 23 for circulating upstream and/or downstream said second heat exchanger 24. The second fluid 27 passed through the second heat exchanger 24 may be mixed with the second fluid coming directly from the source 30. In such an embodiment, said device 1 comprises at least one pipe mixing the second fluid coming from the water source with the second fluid heated through heat exchanger 24, typically to regulate the temperature at the input of the water treatment system.

In one embodiment, said device 1 comprises at least one pipe to evacuate said second fluid downstream said second heat exchanger 24 and thereby by-passing said water treatment system 22, for example to regulate pressure and temperature within the second heat exchanger 24 and at the input of the water treatment system 22.

The water treatment unit 20 may also comprise a recirculation pipe 21 downstream the second heat exchanger 24 and upstream the water treatment system 22, said recirculation pipe 21 feeding the second fluidic circuit 26 upstream the second heat exchanger 24. In such an embodiment, the second fluid is sent to the water treatment system 22 in the circulation pipe 26 and/or is sent upstream the heat exchanger 24 in the recirculation pipe 21.

The heat exchanger 24 allows transferring heat from a first fluid 17 to said second fluid 27.

Solar energy is transformed into electricity by the photovoltaic system 12. The solar panels of the photovoltaic system 12 are cooled by extracting heat by the first heat exchanger 14. The first fluid 17 circulating into the first fluidic circuit 16 is typically a coolant circulating through the first heat exchanger 14, thereby extracting heat from the photovoltaic system 12 at the level of the first heat exchanger 14.

The first fluid 17 is transferring heat to the second fluid 27 in the second heat exchanger 24.

Advantageously, the first fluidic circuit 16 containing said first fluid 17 is physically separate from the second fluidic circuit 26 containing said second fluid 27. Advantageously, according to the invention this specific configuration of the two fluidic circuits improve the thermal management by separating the function of the calorific fluids. The first fluid 17 is dedicated to the transfer of heat from the photovoltaic system 12 through the first heat exchanger 14 and the second fluid 27 is dedicated to the transfer of heat from the water treatment system 22 through the second heat exchanger 24. In one embodiment, the photovoltaic unit 10 comprises one or more materials 11 improving adhesion of the heat exchanger and/or improving heat transfer between the photovoltaic system 12 and the first heat exchanger 14.

Circulation pumps allows circulating the first and second fluids properly according to the skilled person knowledge. Control of temperature, pressure, flow rate, quality of the fluids, etc. are also performed according to the skilled person knowledge.

FIG. 2 is a schematic representation of a system 1 or process according to one embodiment of the present invention.

In FIG. 2, device 1 comprises a photovoltaic system 12, a water treatment system 22, a heat exchanger 44, a pressure exchanger 60, a fluidic circuit 46 for circulating a fluid 47 through said heat exchanger 44 and through said water treatment system 22, said heat exchanger 44 being in thermal contact with said photovoltaic system 12, said device comprising a temperature controller 50 controlling the temperature of the fluid in said fluidic circuit 46, said fluid circulating through said pressure exchanger 60 downstream the water treatment system 22, said pressure exchanger 60 feeding said fluid upstream said water treatment system 22. The fluid to be treated by water treatment system 22 may be fed from a water source 30. The fluid 46 after water treatment may be sent to a storage tank 40. In one embodiment, the photovoltaic unit 10 comprises one or more materials 11 improving heat transfer between the photovoltaic system 12 and the first heat exchanger 14.

FIG. 3 is a schematic representation of a system 201 or process according to one embodiment of the present invention.

In an example, water is collected from a source 230. Said water is circulated in a fluidic circuit 226. Such water represents a fluid 227 according to the invention and circulates in contact with an electric heating system 224. Downstream said electric heating system 224, said fluid 227 passes through a water treatment system 222, for example, a desalination system comprising a reverse osmosis membrane, wherein said fluid 227 is modified as a treated fluid 228 by said water treatment system 222. Downstream said water treatment system 222, the treated fluid 228 is sent to a tank 240 and/or to a recirculation pipe for circulating upstream and/or downstream said electric heating system 224. The fluid 227 coming directly from the source 230 passes through the electric heating system 224. In an embodiment, said electric heating system 224 is controlled by a controller to regulate the temperature at the input of the water treatment system. The PV panel 212 provides electricity 321 to the electric heating system 224. The PV panel 212 provides electricity 322 to the water treatment system 222.

In one embodiment, said device 201 comprises at least one pipe 223 to evacuate said fluid 227 downstream said electric heating system 224 and thereby by-passing said electric heating system 224, for example to regulate pressure and temperature of the fluid in contact with the electric heating system 24 and at the input of the water treatment system 222.

The water treatment unit 220 may also comprise a recirculation pipe 229 downstream the electric heating system 224 and upstream the water treatment system 222, said recirculation pipe 229 feeding the fluidic circuit 226 upstream the electric heating system 224.

Solar energy is transformed into electricity by the photovoltaic system 212. The solar panels of the photovoltaic system 212 are cooled by extracting heat by the cooling system 214. Heat is extracted from the photovoltaic system 212 at the level of the cooling system 214.

The electric heating system 224 is transferring heat to the fluid 227. Electricity 321 is provided to the electric heating system 224 by the photovoltaic system 122.

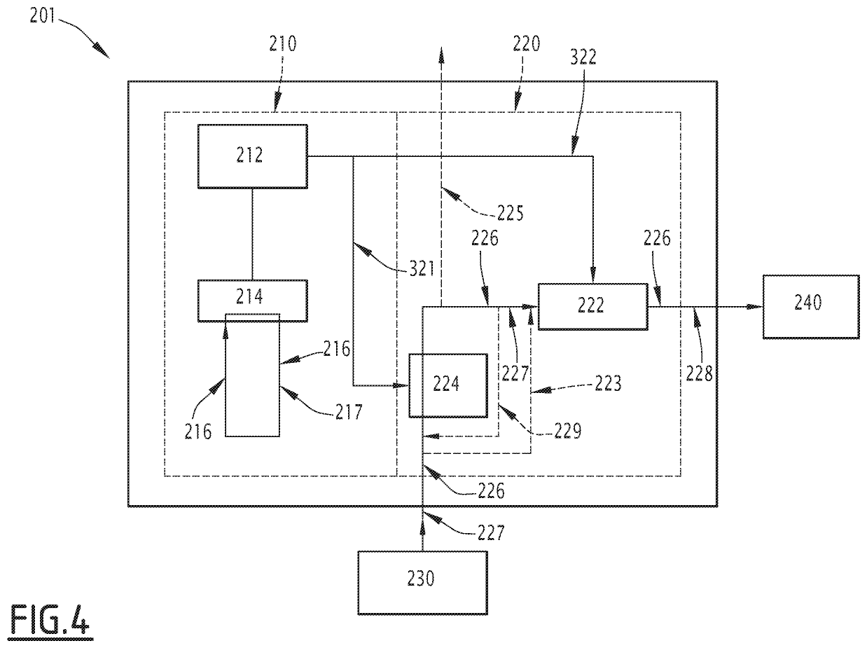

In one embodiment, as illustrated on FIG. 4, a cooling circuit 216 containing said cooling fluid 217 circulates in the cooling system to extract heat from the photovoltaic system 212. Advantageously, the cooling fluid 217 is physically separate from the fluidic circuit 226 containing said fluid 227. Advantageously, according to the invention this specific configuration of the two fluidic circuits improves the thermal management by separating the function of the fluids. The cooling fluid 217 is dedicated to the transfer of heat from the photovoltaic system 212 through the cooling system 214 and the fluid 227 is dedicated to the water treatment system 222. In one embodiment, the photovoltaic unit 210 comprises one or more materials improving adhesion of the heat exchanger and/or improving heat transfer between the photovoltaic system 212 and the heat exchanger 124

Circulation pumps allows circulating the fluids properly according to the skilled person knowledge. Control of temperature, pressure, flow rate, quality of the fluids, etc. are also performed according to the skilled person knowledge.

FIG. 5 is a schematic representation of a system 201 or process according to one embodiment of the present invention.

In FIG. 5, device 201 comprises a photovoltaic system 212, a water treatment system 222, an electric heating system 224, a pressure exchanger 260, a fluidic circuit 46 for circulating a fluid 247 in contact with said electric heating system 224 and through said water treatment system 222, said photovoltaic system 212 providing electricity to work said electric heating system 224, said device comprising a temperature controller 250 controlling the temperature of the fluid in said fluidic circuit 246, said fluid circulating through said pressure exchanger 260 downstream the water treatment system 222, said pressure exchanger 260 feeding said fluid upstream said water treatment system 222. The fluid to be treated by water treatment system 22 may be fed from a water source 230. The fluid 46 after water treatment may be sent to a storage tank 240. In one embodiment, the photovoltaic unit 210 comprises one or more materials improving heat transfer between the photovoltaic system 212 and the heat exchanger 214.

1-33. (canceled)

34. A device comprising a photovoltaic system, a water treatment system, a first heat exchanger, a second heat exchanger, a first fluidic circuit for circulating a first fluid through said first heat exchanger, said first heat exchanger being in thermal contact with said photovoltaic system, and a second fluidic circuit for circulating said second fluid through said second heat exchanger and through said water treatment system.

35. The device according to claim 34, wherein said first fluidic circuit and said second fluidic circuit are in thermal contact in said second heat exchanger.

36. The device according to claim 34, wherein said first fluid circulates in closed loop in said first fluidic circuit.

37. The device according to claim 34, wherein said second fluid exchanges heat with said second heat exchanger before entering said water treatment system.

38. The device according to claim 34, wherein said first fluid exchanges heat with photovoltaic system in said first heat exchanger and before entering said second heat exchanger.

39. The device according to claim 34, wherein said photovoltaic system provides electric energy to said water treatment system.

40. The device according to claim 34, wherein said photovoltaic system provides electric energy to electrically powered devices.

41. The device according to claim 34, wherein said photovoltaic system provides electric energy to said water treatment system and to electrically powered devices.

42. The device according to claim 34, wherein said first heat exchanger reduces the temperature of said photovoltaic system.

43. The device according to claim 34, wherein said first heat exchanger reduces the temperature variations of said photovoltaic system.

44. The device according to claim 34, wherein said first fluid comprises or consists of one or more heat transfer compound

45. The device according to claim 44, wherein the one or more heat transfer compound is one or more phase change materials (PCM).

46. The device according to claim 34, wherein said second fluidic circuit is fed by a source of water to be treated, and said second fluid comprises or consists of water to be treated.

47. The device according to claim 34, wherein said water treatment system is selected from the group consisting of a desalination system, an oxidation system, a bioreactor, a solid-liquid-liquid separation process a liquid-liquid separation process, a liquid gas separation process, a thermal treatment, and combination thereof.

48. The device according to claim 47, wherein the thermal treatment is selected from the group consisting of evaporation, evapo-concentration, humidification-dehumidification, a membrane separation system, a treatment of industrial or domestic water, of natural surface or groundwater including contaminated groundwater.

49. The device according to claim 34, wherein said device comprises one or more controller selected from the group consisting of a controller of the flow rate of the first fluid in the first fluidic circuit, a controller of the flow rate of the second fluid in the second fluidic circuit, a controller of the temperature of the first fluid in the first fluidic circuit, a controller of the temperature of the photovoltaic system, a controller of the temperature of the second fluid in the second fluidic circuit.

50. A process for treating water, wherein said process implements a device according to claim 34, comprising a photovoltaic system, a water treatment system, a first heat exchanger, a second heat exchanger, a first fluidic circuit and a second fluidic circuit, wherein said process comprises circulating a first fluid in said first fluidic circuit and through said first heat exchanger, wherein said first heat exchanger is in thermal contact with said photovoltaic system, and wherein said process comprises circulating a second fluid in said second fluidic circuit, through said second heat exchanger and through said water treatment system.

51. The process according to claim 50, wherein said process comprises desalinizing water from a water source by said water treatment system.

52. The process according to claim 51, wherein said process comprises modifying the composition or the quality of a water from a water source by said water treatment system.
